(19) United States
(12) Patent Application Publication
(10) Pub. No.: US 2024/0054183 A1
(43) Pub. Date: Feb. 15, 2024

(54) INFORMATION ENHANCING METHOD AND INFORMATION ENHANCING SYSTEM

(71) Applicant: Shanghai Maritime University, Shanghai (CN)

(72) Inventor: Changming ZHU, Shanghai (CN)

(21) Appl. No.: 17/802,677

(22) PCT Filed: Jun. 1, 2021
(86) PCT No.: PCT/CN2021/097675

§ 371 Date: Aug. 26, 2022

(30) Foreign Application Priority Data
Jun. 5, 2020 (CN) 202010504326.3

(51) Int. Cl. G06F 18/2132; G06F 18/23213

(52) U.S. Cl. CPC G06F 18/21322; G06F 18/23213

(57) ABSTRACT

Disclosed are an information enhancing method and an information enhancing system. The information enhancing method includes: sampling information to obtain a multi-view dataset labelled with feature and class; creating a fix function to represent “quantity of fixes”; creating a view sub-classifier to represent “quality of fixes”; unifying the “quantity of fixes” and the “quality of fixes” to create a quantity-quality balance model, and resolving the quantity-quality balance model to obtain a fixed multi-view dataset; computing weight of each view and weight of the feature of the fixed information; computing information entropy of a fixed labeled sample based on the weight of the view and the weight of the feature; and selecting a labeled sample based on the information entropy and the weights according to a selected generation manner to generate an unlabeled sample, thereby augmenting the sampled information and realizing information enhancement. By fixing and augmenting the sampled information, the disclosure effectively enhances the sampled information and improves application system performance, thereby offering a better guide to system design.

### FIELD

Embodiments of the present disclosure relate to pattern recognition, and more particularly relate to an information enhancing method and an information enhancing system based on a quantity-quality balance model and information entropy.

### BACKGROUND

Chinese government has launched smart city projects, and local governments have given an active response. For example, Shanghai has launched the 13^{th} Five-Year Plan of Shanghai Municipality on Pushing Forward Smart City Construction and the Several Opinions of Further Accelerating Smart City Construction, requiring innovative fusion of the Internet with logistics, biosecurity, and traffic leveraging advantages of the Internet technologies and service resources, and planning to build a model “future city” and a national-level smart city pilot zone in key regions such as Lin-Gang Special Area of China (Shanghai) Pilot Free Trade Zone. Under this context, cooperation between relevant universities and enterprises has been conducted. For example, Shanghai Maritime University (SMU) located in Lin-Gang Special Area, owing to its location advantage and its featured port—shipping logistics expertise, has cooperated with Shanghai International Port (Group) Co., Ltd., wherein cameras are applied to recognize containers in Yangshan Automatic Container Terminal and jointly monitor and track operations including “loading, unloading, lowering, and lifting” of the containers; thereby realizing a better automation of port operations, reducing manual interference, and ensuring logistics safety. Further, SMU has cooperated with Shanghai Customs and Shanghai Entry-Exit Inspection and Quarantine Bureau to develop a variety of facilities to inspect the items passing through customs, extract and analyze different features of the items, and compare them with various species of biological information in the national integrated database of cross-border monitoring, so as to prevent national key protected biological specimens from being illegally taken out of the border, thereby protecting security of biological information.

### SUMMARY

Embodiments of the present disclosure provide an information enhancing method and an information enhancing system based on a quantity-quality balance model and information entropy, which, by fixing and augmenting sampled information, can effectively enhance the sampled information and improve application system performance.

To achieve the objective above, the present disclosure provides an information enhancing method, comprising steps of:
sampling information to obtain a multi-view dataset labelled with feature and class;
creating a fix function to represent “quantity of fixes”;
creating a view sub-classifier to represent “quality of fixes”;
unifying the “quantity of fixes” and the “quality of fixes” to create a quantity-quality balance model, and resolving the quantity-quality balance model to obtain a fixed multi-view dataset;
computing weight of each view and weight of each feature of the fixed information;
computing information entropy of a fixed labeled sample based on the weight of the view and the weight of the feature; and
selecting a labeled sample to generate an unlabeled sample based on the information entropy and the weights according to a selected generation manner, thereby augmenting the sampled information and realizing information enhancement.

The fix function is:

h(Zⱼ−UⱼVⱼ);
where Zⱼ denotes a hypothetical low-rank matrix, and the hypothetical low-rank matrix Zⱼ corresponding to the feature information Xⱼ of each view is decomposed into a latent representation form Uⱼ and a coefficient matrix Vⱼ of the feature information, wherein UⱼVⱼ denotes the fixed feature information.

The view sub-classifier is:

g(Sⱼ,Wⱼ,Vⱼ,Uⱼ,Yⱼ)=g(g′(UⱼVⱼ,Wⱼ)−YⱼSⱼ);

where g′(UⱼVⱼ, Wⱼ) represents mapping UⱼVⱼ to a corresponding predicted class using a mapping matrix Wⱼ, Yⱼ denotes the class of each view, and Sⱼ is a coefficient matrix of classes.

An objective optimization function is formed using a metric function, and a most value problem of the objective optimization function is created, thereby forming the quantity-quality balance model;
the metric function is:

α(h,g)=α(h(Zⱼ−UⱼVⱼ)/g(Sⱼ,Wⱼ,Vⱼ,Uⱼ,Yⱼ))
the objective function is f ( ) and the quantity-quality balance model is:

$$f ( h , g , α ) = min {\sum }_{j = 1}^{m} f ( h ( {Z}_{j} - {U}_{j} {V}_{j} ) , g ( {S}_{j} , {W}_{j} , {V}_{j} , {U}_{j} , {Y}_{j} ) , α ( h ( {Z}_{j} - {U}_{j} {V}_{j} ) / g ( {S}_{j} , {W}_{j} , {V}_{j} , {U}_{j} , {Y}_{j} ) ) )$$

where m denotes the number of views.

The quantity-quality balance model is resolved using alternating minimization, obtaining optimized form Uⱼ^{o} of the latent representation form Uⱼ and optimized form Vⱼ^{o} of the coefficient matrix Vⱼ of each view, wherein the information of each view is fixed using Xⱼ^{o}=Uⱼ^{o}Vⱼ^{o} to obtain a fixed multi-view data set.

The weight ωⱼ of each view and the corresponding feature weight vector τⱼ are obtained using a multi-view clustering algorithm;

Each feature weight vector is τⱼ={τⱼ₁, . . . , τ_{jc}, . . . , τ_{jd}_{ⱼ}}, where dⱼ denotes the number of features of the view, and τ_{jc} denotes the weight of the c^{th} feature of the view.

The information entropy Hₗ of each fixed labeled sample xₗ is computed using a distance weighted method.

An unlabeled sample x′ᵤ nearest to or farthest from the labelled sample is selected to generate a Universum sample u′ₗ₋ᵤ;

[symbol]

(ω₁, . . . ,ωⱼ, . . . ,ωₘ, . . . ,τ₁, . . . ,τⱼ, . . . ,τₘ,x′ₗ, x′ᵤ)
where the generated Universum sample u′ₗ₋ᵤ and the fixed multi-view dataset are unified into an information enhanced dataset.

The present disclosure further provides a memory, wherein a plurality of instructions are stored in the memory, the instructions being loadable and executable by a processor, the instructions including the information enhancing method.

The present disclosure further provides an information enhancing system, comprising a processor, a memory, and a plurality of cameras;
wherein the cameras are configured to sample information to obtain a multi-view dataset labelled with feature and class;
the memory is configured to store instructions; and
the processor is configured to load and execute the instructions in the memory.

By fixing and augmenting the sampled information, the present disclosure effectively enhances the sampled information and improves application system performance, thereby offering a better guide to system design.

### BRIEF DESCRIPTION OF THE SEVERAL VIEWS OF THE DRAWINGS

FIG. 1 is a flow diagram of an information enhancing method based on a quantity-quality balance model and information entropy according to the present disclosure.

FIG. 2 is a flow diagram of an information enhancing method based on a quantity-quality balance model and information entropy in an embodiment of the present disclosure.

### DETAILED DESCRIPTION

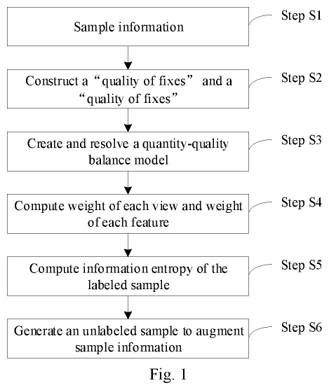

Hereinafter, preferred embodiments of the present disclosure will be illustrated in detail with reference to FIGS. 1˜2.

As shown in FIG. 1, the present disclosure provides an information enhancing method based on a quantity-quality balance model and information entropy, comprising steps of:
Step S1: sampling information to obtain a multi-view dataset labelled with sample feature X and class label Y;
Step S2: decomposing a hypothetical low-rank matrix corresponding to feature information of each view into a latent representation form and a coefficient matrix of feature information, and creating a fix function to represent “quantity of fixes”;
creating a view sub-classifier to represent “quality of fixes”;
Step S3: unifying the “quantity of fixes” and the “quality of fixes” to build a quantity-quality balance model to ensure validity of the fixed information, wherein the quantity-quality balance model is usually resolved using alternating minimization, thereby realizing fix of missed information;
Step S4: computing weight of each view and weight of each feature of the fixed information using a multi-view clustering algorithm;

Step S5: computing information entropy of a fixed labeled sample based on the weight of the view and the weight of the feature to ensure validity of subsequent augmented information; and
Step S6: selecting a high-certainty labeled sample based on the information entropy, weights, and a selected generation method to generate an appropriate unlabeled sample, thereby augmenting the sampled information and finally realizing information enhancement.

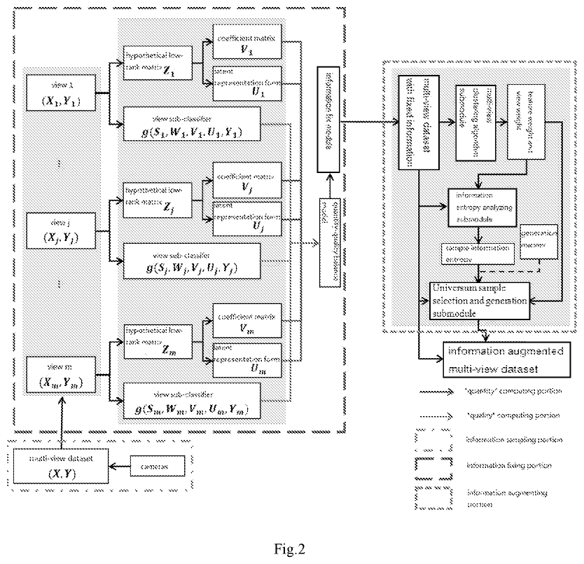

As illustrated in FIG. 2, in an embodiment of the present disclosure, the information enhancing method based on a quantity-quality balance model and information entropy is implemented using an information sampling portion, an information fixing portion, and an information augmenting portion. The information sampling portion is configured to obtain an original multi-view dataset using a plurality of cameras, wherein the cameras refer to Hikvision ColorVu bullet network cameras, model #DS-2CD2T27F(D)WD-LS 2 mega-pixel 1/2.7″ CMOS; the information fixing portion includes a quantity-quality balance model design submodule and an information fixing submodule, wherein the information fixing portion adopts a discrepancy ratio as a core to build a quantity-quality balance model and resolve the model using alternating minimization; the information augmenting portion includes a multi-view clustering algorithm submodule, an information entropy analyzing submodule, and a Universum sample selecting and generating submodule, wherein the information augmenting portion adopts a Universum sample generation algorithm with information entropy as the core.

Further, the information enhancing method based on a quantity-quality balance model and an information entropy in this embodiment comprises:
Step 1: capturing, by cameras, a series of samples, and manually labeling some of the samples, wherein corresponding sample feature is denoted as X, corresponding class label is denoted as Y, and for an unlabeled sample, its class label may be denoted as 0.

Step 2: decomposing hypothetical low-rank matrix Zⱼ corresponding to feature information Xⱼ of each view (hypothetically the j^{th} view) into a latent representation form Uⱼ and a coefficient matrix Vⱼ of the feature information Xⱼ, wherein UⱼVⱼ denotes the fixed feature information, and then the fix function expression h(Zⱼ−UⱼVⱼ) denotes the “quantity of fixes,” where the smaller the value, the more the information to be fixed.

Step 3: for the fixed information UⱼVⱼ, with map matrix Wⱼ as a bridge and Sⱼ representing coefficient matrix of classes, designing, with reference to the manner of mapping feature information X^{t} to class information Y^{t} by weight in the conventional pattern recognition field

$$( i . e . , {X}^{t} {\to }^{{W}^{t}} {Y}^{t} ) ,$$

respective view sub-classifiers to measure impact of the fixed information on the performance of the multi-view learning algorithm, wherein the impact denotes “quality of fixes,” wherein the smaller the value, the greater the fixed information enhances the performance of the multi-view learning algorithm.

The view sub-classifier prefers to:

g(Sⱼ,Wⱼ,Vⱼ,Uⱼ,Yⱼ)=g(g′(UⱼVⱼ,Wⱼ)−YⱼSⱼ);
where g′(UⱼVⱼ, Wⱼ) denotes mapping UⱼVⱼ to a corresponding predicted class by Wⱼ; in actual applications, letting Y denote a class matrix, then S=Y×Y, i.e., representing the coefficient matrix of classes using similarities between classes.

Step 4: forming an objective optimization function ƒ by unifying the “quantity” and “quality” portions of respective views and taking the relation between the “quantity” and “quality” portions as well as the balance metric into consideration by introducing a metric function α, α(h, g)=α(h(Zⱼ−UⱼVⱼ)/g(Sⱼ, Wⱼ, Vⱼ, Uⱼ, Yⱼ)), and constructing most values of the objective optimization function ƒ so as to form a quantity-quality balance model, ƒ(h, g, α)=minΣⱼ₋₁^{m}ƒ(h(Zⱼ−UⱼVⱼ)/g(Sⱼ, Wⱼ, Vⱼ, Uⱼ, Yⱼ), α(h(Zⱼ−UⱼVⱼ)/g(Sⱼ, Wⱼ, Vⱼ, Uⱼ, Yⱼ)),
where m denotes the number of views.

The metric function α is designed with “discrepancy ratio” as the core. Specifically, h(Zⱼ−UⱼVⱼ) denotes the “quantity” of fixes, where the smaller its outcome, the more the information to be fixed; while g(Sⱼ, Wⱼ, Vⱼ, Uⱼ, Yⱼ) denotes the “quality” of fixes, where the smaller its outcome, the greater the fixed information enhances the performance of the multi-view learning algorithm. During the fix process, in order to prevent weighing too heavily on either “quantity” or “quality,” the metric function α(h(Zⱼ−UⱼVⱼ)/g(Sⱼ, Wⱼ, Vⱼ, Uⱼ, Yⱼ)) is introduced, where the function reflects a ratio (i.e., discrepancy ratio) between respective discrepancy measurement results with respect to “quantity” and “quality.” If the outcome of metric function a is greater than 1, it indicates that the fix process weighs more on “quality”; otherwise, the fix process weighs more on “quantity”; if the outcome of the metric function α is equal to 1, it indicates that the “quantity” and the “quality” reach a balance. Therefore, with the discrepancy ratio and by introducing the metric function α, the relationship between “quantity” and “quality” may be reflected by the outcome of the metric function α. Additionally, since it is hard to reach exact 1 of the metric function value in actual scenarios; the range of the metric function value may be usually defined to be approximately 1 when designing the quantity-quality balance model, which may be regarded as reaching an equilibrium between “quantity” and “quality.” With the discrepancy ratio, the relation between “quantity” and “quality” and the balanced metric problem may be effectively resolved, and thus the missed information may be better fixed.

Step 5: optimizing and resolving, by an information fixing submodule, the objective optimization function through alternating minimization to obtain optimizations (i.e., Uⱼ^{o} and Vⱼ^{o}) of the latent representation form Uⱼ and the coefficient matrix Vⱼ of respective views; then, fixing information of each view with Xⱼ^{o}=Uⱼ^{o}Vⱼ^{o} to obtain a fixed multi-view dataset.

Step 6: for the fixed multi-view dataset, analyzing, by a multi-view clustering submodule, contributions and impacts of different views and their feature information with respect to the multi-view clustering algorithm, to obtain the weight ωⱼ of each view and corresponding feature weight vector τⱼ.

Each feature weight vector may be written as τⱼ={τⱼ₁, . . . , τ_{jc}, . . . , τ_{jd}_{ⱼ}}, where dⱼ denotes the number of features of the view, and τ_{jc} denotes the weight of the c^{th} feature of the view.

The feature weight refers to the weight of a feature, and the feature weight vector refers to a vector formed by unification of the weights of a plurality of features under one view.

Step 7: computing and finding a plurality of neighbor samples near each fixed labeled sample xₗ using a weighed distance method based on the view weight and the feature weight vector, and obtaining, by an information entropy analyzing submodule, the information entropy Hₗ of the labeled sample based on the class of the neighbor samples according to an information entropy computing equation H.

The information entropy may reflect class decision certainty of the labeled sample, where a higher certainty indicates a higher validity of a Universum sample generated using priori knowledge of the labeled sample and may enhance class decision capability of the algorithm.

Step 8: first selecting, by a Universum sample selecting and generating submodule, a high-certainty labeled sample x′ₗ based on the information entropy Hₗ, and then selecting a corresponding unlabeled sample x′ᵤ based on a selected generating manner (e.g., generating the Universum sample by computing and selecting an unlabeled sample closest to or farthest from the labeled sample using the distance weighted method), and generating a corresponding Universum sample u′ₗ₋ᵤ according to a function expression [symbol] (ω₁, . . . , ωⱼ, . . . , ωₘ, . . . , τ₁, . . . , τⱼ, . . . , τₘ, x′ₗ, x′ᵤ).

Finally, the generated Universum samples u′ₗ₋ᵤ and the fixed multi-view dataset in step 5 are unified into an information enhanced dataset.

By fixing and augmenting the sampled information, the present disclosure effectively enhances the sampled information and improve application system performance, so as to offer a better guide to system design.

Although the contents of the present disclosure have been described in detail through the foregoing preferred embodiments, it should be understood that the depictions above shall not be regarded as limitations to the present disclosure. After those skilled in the art having read the contents above, many modifications and substitutions to the present disclosure are all obvious. Therefore, the protection scope of the present disclosure should be limited by the appended claims.

1. An information enhancing method, comprising steps of:
sampling information to obtain a multi-view dataset labelled with feature and class;
creating a fix function to represent “quantity of fixes”;
creating a view sub-classifier to represent “quality of fixes”;
unifying the “quantity of fixes” and the “quality of fixes” to create a quantity-quality balance model, and resolving the quantity-quality balance model to obtain a fixed multi-view dataset;
computing weight of each view and weight of each feature of the fixed information;
computing information entropy of a fixed labeled sample based on the weight of the view and the weight of the feature; and
selecting a labeled sample based on the information entropy and the weights according to a selected generation manner to generate an unlabeled sample, thereby augmenting the sampled information and realizing information enhancement.

2. The information enhancing method according to claim 1, wherein the fix function is:
h(Zⱼ−UⱼVⱼ);
where Zⱼ denotes a hypothetical low-rank matrix, and the hypothetical low-rank matrix Zⱼ corresponding to the feature information Xⱼ of each view is decomposed into a latent representation form Uⱼ and a coefficient matrix Vⱼ of the feature information, wherein UⱼVⱼ denotes the fixed feature information.

3. The information enhancing method according to claim 2, wherein the view sub-classifier is:
g(Sⱼ,Wⱼ,Vⱼ,Uⱼ,Yⱼ)=g(g′(UⱼVⱼ,Wⱼ)−YⱼSⱼ);
where g′(UⱼVⱼ, Wⱼ) represents mapping UⱼVⱼ to a corresponding predicted class using a mapping matrix Wⱼ, Yⱼ denotes the class of each view, and Sⱼ is a coefficient matrix of classes.

4. The information enhancing method according to claim 3, wherein an objective optimization function is formed using a metric function, and most values of the objective optimization function are resolved to form the quantity-quality balance model;
the metric function is:
α(h,g)=α(h(Zⱼ−UⱼVⱼ)/g(Sⱼ,Wⱼ,Vⱼ,Uⱼ,Yⱼ))
the objective function is f ( ) and the quantity-quality balance model is:
$$f ( h , g , α ) = min {\sum }_{j = 1}^{m} f ( h ( {Z}_{j} - {U}_{j} {V}_{j} ) , g ( {S}_{j} , {W}_{j} , {V}_{j} , {U}_{j} , {Y}_{j} ) , α ( h ( {Z}_{j} - {U}_{j} {V}_{j} ) / g ( {S}_{j} , {W}_{j} , {V}_{j} , {U}_{j} , {Y}_{j} ) ) )$$
where m denotes the number of views.

5. The information enhancing method according to claim 4, wherein the quantity-quality balance model is resolved using alternating minimization to obtain optimized form Uⱼ^{o} of the latent representation form Uⱼ and optimized form Vⱼ^{o} of the coefficient matrix Vⱼ of each view, wherein the information of each view through Xⱼ^{o}=Uⱼ^{o}Vⱼ^{o}, a fixed multi-view data set.

6. The information enhancing method according to claim 5, wherein weight ωⱼ of each view and corresponding feature weight vector τⱼ are obtained using a multi-view clustering algorithm;
each feature weight vector is τⱼ={τⱼ₁, . . . , τ_{jc}, . . . , τ_{jd}_{ⱼ}}, where dⱼ denotes the number of features of the view, and τ_{jc} denotes the weight of the c^{th} feature of the view.

7. The information enhancing method according to claim 6, wherein the information entropy Hₗ of each fixed labeled sample xₗ is computed using a distance weighted method.

8. The information enhancing method according to claim 7, wherein an unlabeled sample x′ᵤ nearest to or farthest from the labelled sample is selected to generate a Universum sample u′ₗ₋ᵤ; [symbol]
(ω₁, . . . ,ωⱼ, . . . ,ωₘ, . . . ,τ₁, . . . ,τⱼ, . . . ,τₘ,x′ₗ, x′ᵤ)
where the generated Universum sample u′ₗ₋ᵤ and the fixed multi-view dataset are unified into an information enhanced dataset.

9. A memory, wherein a plurality of instructions are stored in the memory, the instructions being loadable and executable by a processor, the instructions including the information enhancing method according to claim 1.

10. An information enhancing system, comprising: a processor, the memory according to claim 9, and a plurality of cameras;
wherein the cameras are configured to sample information to obtain a multi-view dataset labelled with feature and class;
the memory is configured to store instructions; and
the processor is configured to load and execute the instructions in the memory.
